(19) United States
(12) Patent Application Publication
(10) Pub. No.: US 2020/0369409 A1
(43) Pub. Date: Nov. 26, 2020

(54) WING BASE POSITIONED TOWARDS THE FRONT OF AIRCRAFT AND SPACECRAFT RELATED VEHICLES OR PROPELLED/PROJECTILE OBJECTS TO BECOME MORE STREAMLINED

(71) Applicant: Taylor DiAnte' Brown, Jackson, MS (US)

(72) Inventor: Taylor DiAnte' Brown, Jackson, MS (US)

(21) Appl. No.: 16/420,552

(22) Filed: May 23, 2019

(51) Int. Cl. B64F 5/00; B64C 3/00

(52) U.S. Cl. CPC B64F 5/00; B64C 3/00

(57) ABSTRACT

The base of the wings of a vehicle or object generally come out of the body at the middle or towards the back. When the wing base come out towards the front of the body of a vehicle or object, it becomes more streamlined. By becoming more streamlined, the vehicle or object can achieve better performances in drag reduction and stability.

### BACKGROUND OF THE INVENTION

Birds have always been aerodynamically efficient. Through examining the shape of bird wings, we have been able to learn how they maintain flight. In ways, we have created our own versions of these wings so we can achieve flight with our aircrafts. The main forces that act on an aircraft are lift and drag. Lift sustains an aircraft in the air while drag pushes against the aircraft as a consequence of the aircraft moving forward. There have been different methodologies in reducing drag and increasing lift on aircraft by changing the shape of the wings. However, these forces on an aircraft can be affected by also changing the location of the wings.

This invention is to be applied in the field of fluid mechanics. This invention targets making a vehicle or object more streamlined and therefore reducing drag and increasing stability. An aircraft produces less drag if the base of the wings is closer towards the front of the aircraft. The less drag an aircraft produces, the more stable it becomes. As the base of the wings move further away from the front of the aircraft, the aircraft produces more drag and becomes less stable due to drag.

### BRIEF SUMMARY OF THE INVENTION

Most vehicles and objects that consist of wings, have the base of their wings being positioned in the middle. However, this invention promotes the base of the wings of to be moved toward the front to become more streamlined. By moving the base of the wings towards the front of the vehicle or object, it reduces drag.

### BRIEF DESCRIPTION OF THE DRAWINGS

FIG. 1A-FIG. 1A displays the front view of the aircraft. FIG. 1A displays the number 1 pointing to the base of the wing being positioned towards the front of the main body of the aircraft.

FIG. 1B-FIG. 1B displays the top view of the aircraft. FIG. 1B displays two position locations for the wing base denoted as the numbers 2 and 3. The number 2 highlights the section of the main body of the aircraft where the usual location of the old wing base configurations would be, which are towards the middle and occasionally towards the back. The number 3 pointing to the intersection of main body of the aircraft and the wing denotes the new location of where the base of the wing start, which is towards the front. The number 3 in FIG. 1B. corresponds to the number 1 in FIG. 1A. The number 4 is pointing towards the middle of the base of the wing. The curve line with two slanted lines intersecting its middle on the left wing or left side of the figure denotes the end point of interest of the aircraft.

FIG. 1C-FIG. 1C displays the side view of the aircraft. FIG. 1C displays the number 5 pointing to the new location of where the base of the wing start, which is towards the front. The number 5 in FIG. 1C corresponds to the number 3 in FIG. 1B. and the number 1 in FIG. 1A.

### DETAILED DESCRIPTION OF THE INVENTION

The terminology within this section is used for describing the characteristics, functionality, and uses thereof. The term “and/or” used within a sentence denotes any and all combinations of one or more of the associated listed elements. The singular forms of “a,” “an,” and “the” are also intended to include the plural forms unless otherwise stated. It is presumed that scientific, technical, engineering, and mathematical terms are universally defined. It is further understood that these definitions are not limited to their common definitions and may be found through the use of dictionaries or other sources.

There are multiple types of vehicles and objects that can utilize this invention such as: an aircraft, spacecraft, propelled object, and projectile object. The following definitions of an aircraft, spacecraft, propelled object, and projectile object are simply defined, and are not limited to these definitions. An aircraft is any vehicle made to fly within the Earth's atmosphere. A spacecraft is any vehicle made to exit the Earth's atmosphere. A propelled object is any object that has a propulsion system to propel the object in a designated direction. A projectile object is any object that has the capability of being launched from a person's hand or a platform.

The wings on a vehicle or object sustain it in flight. Depending on how the wings are shaped can affect how streamlined a vehicle or object is while also affecting lift and drag. Streamlined is defined as but not limited to, a shape of a vehicle or object that is resistant to drag. Lift is defined as but not limited to, the force that sustains the vehicle or object in air. Drag is the opposing force operating on the surface of a vehicle or object while it is in travel. This invention entails changing the location of where the wings come out of the body of the vehicle or object to make it more streamlined. “Come out of the body” or “coming out of the body” describes the location where the base of the wings is connected to the main body of the vehicle or object. For example, in using the older wing configurations of an aircraft, the wings come out of the body towards the middle and sometimes the back. “Older” describes the base of the wing configurations coming out towards the middle or back, but not towards the front.

In applying the invention, if the wings come out of the body towards the front of the vehicle or object, it can reduce drag. Being “towards the front” describes the wing base positioning, which is in the section that is beyond the middle of a vehicle or object. The middle is where the length of a vehicle or object can split into two same length pieces. To describe the middle further, consider a rectangular block with a length of 12 inches. The middle of this block is where the block can divide into two 6-inch pieces. A wing configuration is said to be towards the front of a vehicle or object if the middle of the base of the wing is not aligned with the middle of the main body of a vehicle or object, and its location is closer to the front rather than the back.

It is important to note that there are some airplanes that have wing bases made towards the front based on the provided explanation of what being “towards the front” is. However, this may be because of other reasons instead of specifically to become more streamlined. If a vehicle or object reduces drag and/or becomes more stable as a result of becoming streamlined, then this describes the invention. This invention describes all wing configuration designs that have the base of their wings located towards the front of the vehicle or object to become more streamlined.

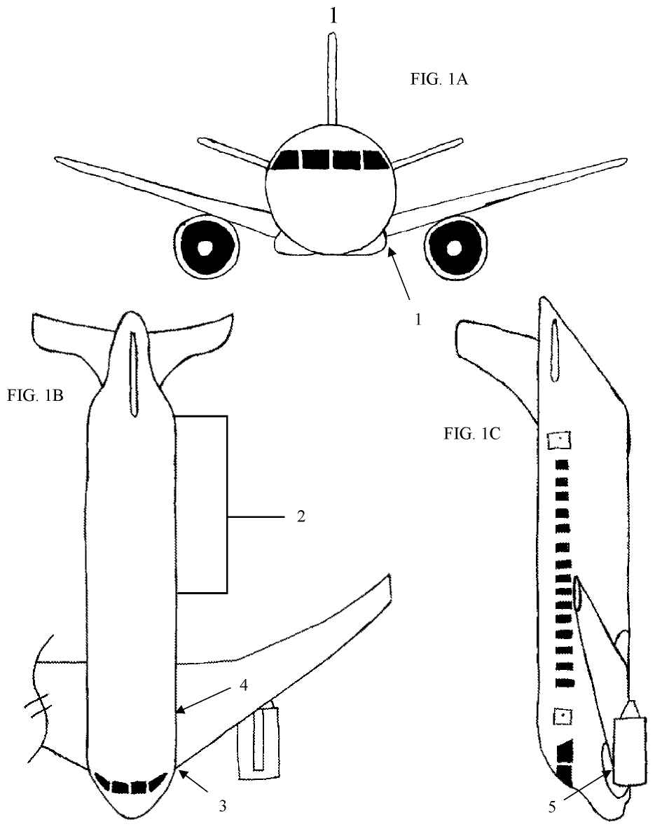

FIGS. 1A, 1B, and 1C display examples of the base of the wings being located towards the front of an aircraft. It is presumed that these figures do not limit the scope or usefulness of the invention. For example, there can be different vehicles or objects with different wing shapes whose wing base is towards the front as well. The wing bases may also start at the nose instead of after the nose.

FIG. 1A displays the front view of the aircraft. FIG. 1A displays the number 1 pointing to the base of the wing being positioned towards the front of the main body of the aircraft. FIG. 1B displays the top view of the aircraft. FIG. 1B displays two position locations for the wing base denoted as the numbers 2 and 3. The number 2 highlights the section of the main body of the aircraft where the usual location of the old wing base configurations would be, which are towards the middle and occasionally towards the back. The number 3 pointing to the intersection of main body of the aircraft and the wing denotes the new location of where the base of the wing start, which is towards the front. The number 3 in FIG. 1B. corresponds to the number 1 in FIG. 1A. The number 4 is pointing towards the middle of the base of the wing. As described earlier, the middle of the base of the wing is closer to the nose of the aircraft, therefore the wing configuration is towards the front. The curve line with two slanted lines intersecting its middle on the left wing or left side of the figure denotes the end point of interest of the aircraft.

FIG. 1C displays the side view of the aircraft. FIG. 1C displays the number 5 pointing to the new location of where the base of the wing start, which is towards the front. The number 5 in FIG. 1C corresponds to the number 3 in FIG. 1B. and the number 1 in FIG. 1A. It is presumed that the processes, manufacturability, and assembly of the wings coming out of the front body of the aircraft, spacecraft, propelled object, or projectile object should follow the same or similar guidelines in how the older designs of wing configurations for vehicles and objects are made.

The claimed invention is:

1. Aircraft and spacecraft related vehicle(s) or propelled/projectile object(s) comprising of the base of the wing(s) being positioned towards the front to become more streamlined, as defined in the detailed description.
